(19) United States
(12) Patent Application Publication
(10) Pub. No.: US 2026/0242276 A1
(43) Pub. Date: Aug. 20, 2026

(54) Li2O-B2O3-SiO2 System Glass Ceramic and Preparation Method Thereof

(71) Applicant: MING CHI UNIVERSITY OF TECHNOLOGY, New Taipei City (TW)

(72) Inventors: Jun-Yan QIU, New Taipei City (TW); Szu-Ting HUANG, New Taipei City (TW); Kuei-Chih FENG, New Taipei City (TW)

(21) Appl. No.: 19/053,535

(22) Filed: Feb. 14, 2025

(51) Int. Cl. C03C 10/00; C03B 32/02

(52) U.S. Cl. CPC C03C 10/0009; C03C 10/0054; C03B 32/02; C03C 2204/00

(57) ABSTRACT

The present disclosure provides a Li₂O—B₂O₃—SiO₂ system glass ceramic, characterized in that the Li₂O—B₂O₃—SiO₂ system glass ceramic comprises 89.87 to 92.86 wt % SiO₂, 4.53 to 4.71 wt % B₂O₃, and 2.61 to 5.42 wt % Li₂O. The present disclosure also provides a preparation method of the foregoing Li₂O—B₂O₃—SiO₂ system glass ceramic. The method comprises the following steps: mixing raw materials comprising at least Li₂CO₃, H₃BO₃, and SiO₂; melting; water quenching; grinding; wet fine grinding; adding a binder; and low-temperature sintering to obtain the Li₂O—B₂O₃—SiO₂ system glass ceramic, characterized in that the raw materials comprise 6 to 12 wt % Li₂CO₃, 6.6 to 7.5 wt % H₃BO₃, and 80.5 to 86.5 wt % SiO₂, and the low-temperature sintering step is performed at a sintering temperature of 800 to 1100° C. The Li₂O—B₂O₃—SiO₂ system glass ceramic of the present disclosure can achieve a low permittivity and a low dielectric loss under low-temperature sintering. Its excellent material properties demonstrate its potential as a low-temperature co-fired ceramic (LTCC) for applications in high-frequency communication devices.

### TECHNICAL FIELD

The present disclosure relates to glass ceramics. Specifically, the present disclosure relates to a low-temperature co-fired Li₂O—B₂O₃—SiO₂ system glass ceramic with low permittivity and low dielectric loss.

### BACKGROUND

In recent years, low temperature co-fired ceramic (LTCC) has been widely used in high-frequency communication device with features such as miniaturization, high operating frequency and low energy loss. LTCC materials need to have a low permittivity, low dielectric loss and suitable coefficient of thermal expansion in order to be effective in these applications. A key advantage of LTCC technology lies in its ability to co-fire with a variety of metal electrode materials (e.g., silver, copper, gold, etc.) with low melting points at relatively low sintering temperatures, thereby avoiding damage to components caused by high temperatures.

Common LTCC materials mainly comprise glass ceramic systems, microcrystalline glass systems and amorphous glass systems. Among them, glass ceramics are not easily hydrolyzed in water or alcohol, have excellent chemical resistance, and are resistant to moisture, oxidation, and corrosion, thereby maintaining stable properties in harsh environments and helping to extend the lifespan of electronic components. In addition, glass ceramics have the effect of generating liquid phase sintering, and will gradually form a two-phase coexistence state in the sintering process.

However, the main problem with LTCC technology lies in how to maintain excellent microwave dielectric properties of the prepared glass ceramic material even at low sintering temperatures. Although conventional silicate-based glass ceramics have good high-frequency property, they usually require higher sintering temperatures, which is unfavorable for LTCC applications.

In order to make glass ceramic materials meet the requirements of reducing sintering temperature while maintaining dielectric properties, prior art on the modification of glass ceramics has indicated that the addition of B₂O₃ to the Li₃Mg₂NbO₆ system can reduce the sintering temperature (Ping Zhang et al., Journal of Alloys and Compounds 2017, 690, 688-691.). In lithium silicate ceramic materials, the Li/Si molar ratio and sintering temperature are the key factors for achieving ideal microwave dielectric properties (Chengli Sun et al., Journal of Materials Science: Materials in Electronics 2022, 33, 4043-4050.). The CaO—B₂O₃—SiO₂ (CBS) glass ceramic system, primarily consisting of the wollastonite phase, can exhibit good microwave dielectric properties at high frequencies. However, its sintering temperature is usually higher, making it unfavorable for LTCC applications (Chao Dong et al., Crystals 2023, 13, 748.). In addition, it has been shown that alkali metals can disrupt the glass network structure, which not only maintains the excellent properties of high-silica materials but also reduces the viscosity of the glass melt, thereby potentially achieving lower processing temperatures (Neetu Bansal et al., Ceramics International 2023, 49, 2998-3006.).

From these studies, it can be seen that alkali metals (especially lithium) and boron play a critical role in the modification of glass ceramics, not only enhancing the meltability of the glass to effectively reduce the sintering temperature, but also optimizing the structure of the glass, enhancing the dielectric properties, and improving the material's adaptability in low-temperature co-fired environments, which makes it one of the ideal options to meet low-temperature sintering requirements of LTCC. However, further optimization of the material composition of glass ceramics is still required to meet the stringent demands of LTCC applications. Specifically, it remains necessary to develop a glass ceramic material that can achieve an ideal balance between low sintering temperature, low permittivity, and high Qf value.

### SUMMARY

Accordingly, the present disclosure provides a low-temperature co-fired ceramic. Specifically, the present disclosure provides a Li₂O—B₂O₃—SiO₂ system glass ceramic (LBS glass ceramic) and a preparation method thereof. Compared to conventional glass ceramics, the Li₂O—B₂O₃—SiO₂ system glass ceramic of the present disclosure can achieve a low permittivity and low dielectric loss under low-temperature sintering. Its excellent material properties demonstrate its potential as a low-temperature co-fired ceramic (LTCC) for applications in high-frequency communication devices.

In an aspect, the present disclosure provides a Li₂O—B₂O₃—SiO₂ system glass ceramic, characterized in that the Li₂O—B₂O₃—SiO₂ system glass ceramic comprises 89.87 to 92.86 wt % SiO₂, 4.53 to 4.71 wt % B₂O₃, and 2.61 to 5.42 wt % Li₂O.

In some embodiments, the permittivity (εᵣ) value of the Li₂O—B₂O₃—SiO₂ system glass ceramic is 4.7 to 5.4.

In some embodiments, the Qf value of the Li₂O—B₂O₃—SiO₂ system glass ceramic is 1900 to 2600 GHz.

In some embodiments, the Vickers microhardness (MHV) value of the Li₂O—B₂O₃—SiO₂ system glass ceramic is 190 to 249 kgf/mm².

In some embodiments, the density of the Li₂O—B₂O₃—SiO₂ system glass ceramic is 1.5 to 2.0 g/cm³.

In some embodiments, the Li₂O—B₂O₃—SiO₂ system glass ceramic is obtained by sintering at a sintering temperature of 800 to 1100° C.

In another aspect, the present disclosure provides a preparation method of the foregoing Li₂O—B₂O₃—SiO₂ system glass ceramic. The method comprises the following steps: mixing raw materials comprising at least Li₂CO₃, H₃BO₃, and SiO₂; melting; water quenching; grinding; wet fine grinding; adding a binder; and low-temperature sintering to obtain the Li₂O—B₂O₃—SiO₂ system glass ceramic, and is characterized in that the raw materials comprise 6 to 12 wt % Li₂CO₃, 6.6 to 7.5 wt % H₃BO₃, and 80.5 to 86.5 wt % SiO₂, and the low-temperature sintering step is performed at a sintering temperature of 800 to 1100° C.

In some embodiments, the melting step of the method is performed in a furnace at a temperature of 1500 to 1580° C. wherein the temperature of 1500 to 1580° C. is maintained for 4 to 8 hours.

In some embodiments, the wet fine grinding step of the method is performed until the particle size is <5 μm.

In some embodiments, the low-temperature sintering step of the method is performed for 1 to 4 hours.

The Li₂O—B₂O₃—SiO₂ system glass ceramic of the present disclosure effectively reduces the sintering temperature to 800° C., thereby enabling it to be co-fired with metal electrodes with low melting points without damaging components, making it suitable for low-temperature co-fired ceramic (LTCC) applications. Furthermore, it achieves multiple technical effects, including maintaining a low permittivity (4.7 to 5.4) and a high Qf value (1900 to 2600 GHz) within the microwave frequency range, meeting the requirements of high-frequency communication applications. Meanwhile, the Li₂O—B₂O₃—SiO₂ system glass ceramic of the present disclosure possesses appropriate crystalline phases, density, and hardness, ensuring its sufficient surface hardness and chemical stability, which brings resistance to moisture, oxidation, and corrosion, and helps to enhance the stability of properties in harsh environments and extend the lifespan of components.

### BRIEF DESCRIPTION OF THE DRAWINGS

FIG. 1A represents the XRD patterns of comparative examples BS7.5, BS15, and BS25 prepared at sintering temperatures of 900° C., 950° C., or 1000° C. of the present disclosure; and FIG. 1B represents the Raman spectra of comparative examples BS7.5, BS15, and BS25 prepared at sintering temperatures of 900° C., 950° C., or 1000° C.

FIG. 2A, FIG. 2B, FIG. 2C, FIG. 2D, FIG. 2E, FIG. 2F, FIG. 2G, FIG. 2H and FIG. 2I represent the FE-SEM micrographs of comparative examples BS7.5, BS15, and BS25 prepared at sintering temperatures of 900° C., 950° C., or 1000° C. of the present disclosure.

FIG. 3A represents the Qf values of comparative examples BS7.5, BS15, and BS25 prepared at sintering temperatures of 900° C., 950° C., or 1000° C. of the present disclosure; FIG. 3B represents the permittivities of comparative examples BS7.5, BS15, and BS25 prepared at sintering temperatures of 900° C., 950° C., or 1000° C.; and FIG. 3C represents the densities of comparative examples BS7.5, BS15, and BS25 prepared at sintering temperatures of 900° C., 950° C., or 1000° C.

FIG. 4 represents the Vickers microhardness (MHV) values of comparative examples BS7.5, BS15, and BS25 prepared at sintering temperatures of 900° C., 950° C., or 1000° C.

FIG. 5A represents the DSC curves of examples LBS08, LBS10, and LBS12 prepared at sintering temperatures of 900° C., 950° C., or 1000° C. of the present disclosure; FIG. 5B represents the XRD patterns of examples LBS08, LBS10, and LBS12 prepared at sintering temperatures of 900° C., 950° C., or 1000° C.; and FIG. 5C represents the Raman spectra of examples LBS08, LBS10, and LBS12 prepared at sintering temperatures of 900° C., 950° C., or 1000° C.

FIG. 6A, FIG. 6B, FIG. 6C, FIG. 6D, FIG. 6E, FIG. 6F, FIG. 6G, FIG. 6H, FIG. 6I, FIG. 6J, FIG. 6K and FIG. 6L represent the FE-SEM micrographs of examples LBS08, LBS10, LBS12, and comparative example BS7.5 prepared at sintering temperatures of 900° C., 950° C., or 1000° C. of the present disclosure.

FIG. 7A represents the Qf values of examples LBS08, LBS10, LBS12, and comparative example BS7.5 prepared at sintering temperatures of 900° C., 950° C., or 1000° C. of the present disclosure; FIG. 7B represents the permittivities of examples LBS08, LBS10, LBS12, and comparative example BS7.5 prepared at sintering temperatures of 900° C., 950° C., or 1000° C.; and FIG. 7C represents the densities of examples LBS08, LBS10, LBS12, and comparative example BS7.5 prepared at sintering temperatures of 900° C., 950° C., or 1000° C.

FIG. 8 represents the Vickers microhardness (MHV) values of examples LBS08, LBS10, and LBS12 prepared at sintering temperatures of 900° C., 950° C., or 1000° C.

### DETAILED DESCRIPTION

The specific embodiments of the present disclosure are illustrated via the following embodiments and examples, allowing the technical means provided by the present disclosure to be readily understood by those skilled in the art. It should be noted that the following embodiments and examples are provided solely to explain the present disclosure and are not intended to limit the scope of the present disclosure.

In an aspect, the present disclosure utilizes raw materials with specific proportions of Li₂CO₃, H₃BO₃, and SiO₂, enabling the Li₂O—B₂O₃—SiO₂ system glass ceramic of the present disclosure prepared through low-temperature sintering to exhibit excellent material properties, such as a low permittivity and a high Qf value (indicating low dielectric loss).

The Li₂O—B₂O₃—SiO₂ system glass ceramic of the present disclosure comprises 89.87 to 92.86 wt % SiO₂, 4.53 to 4.71 wt % B₂O₃, and 2.61 to 5.42 wt % Li₂O, preferably 89.87 to 91.89 wt % SiO₂, 4.60 to 4.71 wt % B₂O₃, and 3.52 to 5.42 wt % Li₂O, more preferably 89.87 to 90.89 wt % SiO₂, 4.65 to 4.71 wt % B₂O₃, and 4.46 to 5.42 wt % Li₂O, and more preferably about 89.87 wt % SiO₂, about 4.71 wt % B₂O₃, and about 5.42 wt % Li₂O.

The permittivity (εᵣ) of the Li₂O—B₂O₃—SiO₂ system glass ceramic of the present disclosure is 4.7 to 5.4, preferably 4.7 to 5.0.

The Qf value of the Li₂O—B₂O₃—SiO₂ system glass ceramic of the present disclosure is 1900 to 2600 GHz, preferably 2300 to 2600 GHz.

The Vickers microhardness (MHV) value of the Li₂O—B₂O₃—SiO₂ system glass ceramic of the present disclosure is 190 to 249 kgf/mm², preferably about 249 kgf/mm².

The Li₂O—B₂O₃—SiO₂ system glass ceramic of the present disclosure is obtained by sintering at a sintering temperature of 800 to 1100° C., preferably at a sintering temperature of 900 to 1000° C., more preferably at a sintering temperature of 900 to 950° C., and more preferably at a sintering temperature of about 900° C.

In another aspect, the preparation method of the foregoing Li₂O—B₂O₃—SiO₂ system glass ceramic of the present disclosure comprises the following steps:
(1) Mixing raw materials comprising at least Li₂CO₃, H₃BO₃ and SiO₂: Mixing H₃BO₃ (6.6 to 7.5 wt %), SiO₂ (80.5 to 86.5 wt %) and Li₂CO₃ (6 to 12 wt %) powders;
(2) Melting: Next, melting is performed in a furnace at a temperature of 1500 to 1580° C. wherein the temperature of 1500 to 1580° C. is maintained for 1 to 8 hours;
(3) Water quenching: Next, water quenching is performed and the mixture is poured out to obtain Li₂O—B₂O₃—SiO₂ glass;
(4) Grinding: Next, grinding the foregoing Li₂O—B₂O₃—SiO₂ glass into glass powder using a grinding machine;
(5) Wet fine grinding: Next, adding water, alcohol, dispersants, etc. to the foregoing glass powder and performing wet fine grinding until the particle size is <5 μm;
(6) Adding binder: Next, adding a binder (e.g., polyvinyl alcohol (PVA)) and forming the material into blocks through uniaxial pressing;
(7) Low-temperature sintering: Lastly, low-temperature sintering is performed at a sintering temperature range of 800 to 1100° C. for 1 to 4 hours to obtain the Li₂O—B₂O₃—SiO₂ system glass ceramic.

In the method of preparing the foregoing Li₂O—B₂O₃—SiO₂ system glass ceramics of the present disclosure, the sintering temperature can be 800 to 1100° C., preferably 900 to 1000° C., more preferably 900 to 950° C., and more preferably at a sintering temperature of about 900° C.

In the preparation method of the foregoing Li₂O—B₂O₃—SiO₂ system glass ceramics of the present disclosure, the raw materials can comprise 6 to 12 wt % Li₂CO₃, 6.6 to 7.5 wt % H₃BO₃, and 80.5 to 86.5 wt % SiO₂, preferably 6 to 12 wt % Li₂CO₃, 7.5 wt % H₃BO₃, and 80.5 to 86.5 wt % SiO₂, more preferably 8 to 12 wt % Li₂CO₃, 7.5 wt % H₃BO₃, and 80.5 to 84.5 wt % SiO₂, more preferably 10 to 12 wt % Li₂CO₃, 7.5 wt % H₃BO₃, and 80.5 to 82.5 wt % SiO₂, and more preferably about 12 wt % Li₂CO₃, about 7.5 wt % H₃BO₃, and about 80.5 wt % SiO₂.

In the preparation method of the foregoing Li₂O—B₂O₃—SiO₂ system glass ceramics of the present disclosure, when the raw materials comprise 6 wt % Li₂CO₃, 7.5 wt % H₃BO₃, and 86.5 wt % SiO₂, the prepared Li₂O—B₂O₃—SiO₂ system glass ceramic comprises about 92.86 wt % SiO₂, about 4.53 wt % B₂O₃, and about 2.61 wt % Li₂O. In the preparation method of the foregoing Li₂O—B₂O₃—SiO₂ system glass ceramics of the present disclosure, when the raw materials comprise 8 wt % Li₂CO₃, 7.5 wt % H₃BO₃, and 84.5 wt % SiO₂, the prepared Li₂O—B₂O₃—SiO₂ system glass ceramic comprises about 91.89 wt % SiO₂, about 4.60 wt % B₂O₃, and about 3.52 wt % Li₂O. In the preparation method of the foregoing Li₂O—B₂O₃—SiO₂ system glass ceramics of the present disclosure, when the raw materials comprise 10 wt % Li₂CO₃, 7.5 wt % H₃BO₃, and 82.5 wt % SiO₂, the prepared Li₂O—B₂O₃—SiO₂ system glass ceramic comprises about 90.89 wt % SiO₂, about 4.65 wt % B₂O₃, and about 4.46 wt % Li₂O. In the preparation method of the foregoing Li₂O—B₂O₃—SiO₂ system glass ceramics of the present disclosure, when the raw materials are composed of 12 wt % Li₂CO₃, 7.5 wt % H₃BO₃, and 80.5 wt % SiO₂, the prepared Li₂O—B₂O₃—SiO₂ system glass ceramic comprises about 89.87 wt % SiO₂, about 4.71 wt % B₂O₃, and about 5.42 wt % Li₂O.

### Examples

[Synthesis of Li₂O—B₂O₃—SiO₂ System Glass Ceramics]

The powders of H₃BO₃, SiO₂, and Li₂CO₃ were mixed and melting was performed in a furnace at about 1500° C., with the temperature maintained for 1 to 4 hours. Subsequently, water quenching was performed and the mixture was poured out to obtain Li₂O—B₂O₃—SiO₂ glass. Next, grinding the foregoing Li₂O—B₂O₃—SiO₂ glass into glass powder using a grinding machine, and the foregoing glass powder was then wet fine ground until the particle size was <5 μm. Next, polyvinyl alcohol (PVA) was added as a binder, and then the material was formed into blocks through uniaxial pressing. Finally, low-temperature sintering was performed at a sintering temperature of 900° C., 950° C., or 1000° C. for 0.5 to 2 hours, thereby obtaining the Li₂O—B₂O₃—SiO₂ system glass ceramic (LBS glass ceramic). The weight percentages of H₃BO₃, SiO₂, and Li₂CO₃ powders used for synthesizing each Li₂O—B₂O₃—SiO₂ system glass ceramic were as follows:

| Li₂O—B₂O₃—SiO₂ | Li₂CO₃ | H₃BO₃ | SiO₂ |
|---|---|---|---|
| system glass ceramics | (wt %) | (wt %) | (wt %) |
| LBS06 | 6 | 7.5 | 86.5 |
| LBS08 | 8 | 7.5 | 84.5 |
| LBS10 | 10 | 7.5 | 82.5 |
| LBS12 | 12 | 7.5 | 80.5 |

The B₂O₃—SiO₂ glass ceramics (BS glass ceramics) as the comparative examples were prepared with the same method as described above, except that the step of adding Li₂CO₃ during the preparation of the B₂O₃—SiO₂ glass ceramics was omitted. The weight percentages of H₃BO₃ and SiO₂ powders used for synthesizing each B₂O₃-SiO₂ glass ceramic were as follows:

| B₂O₃—SiO₂ | H₃BO₃ | SiO₂ |
|---|---|---|
| glass ceramics | (wt %) | (wt %) |
| BS7.5 | 7.5 | 92.5 |
| BS15 | 15 | 85 |
| BS25 | 25 | 75 |

The following describes the structure, dielectric properties, and mechanical properties of each LBS glass ceramic and BS glass ceramic prepared with different component proportions and sintering temperatures.

### [Microstructure of BS Glass Ceramics]

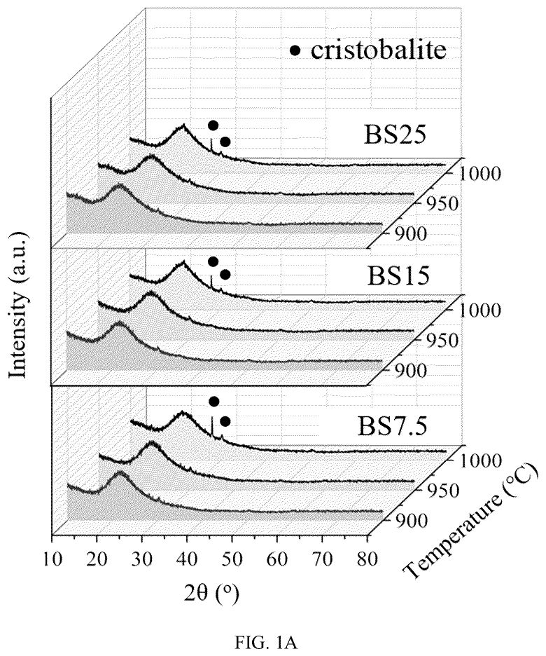

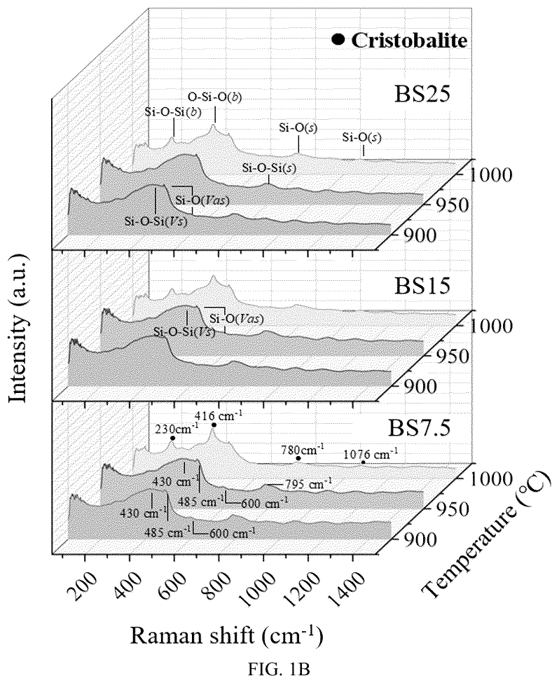

The microstructure of each BS glass ceramic prepared at different sintering temperatures was analyzed using XRD patterns and Raman spectra. As shown in FIG. 1A and FIG. 1B, the BS7.5, BS15, and BS25 prepared at sintering temperatures of 900° C. and 950° C. exhibited an amorphous phase structure, while exhibited a cristobalite phase structure when prepared at the sintering temperature of 1000° C., wherein the phase structure intensity is particularly obvious in BS7.5.

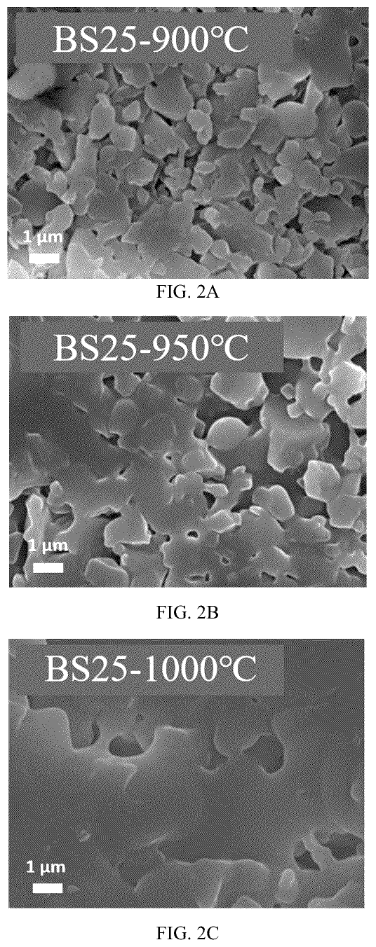

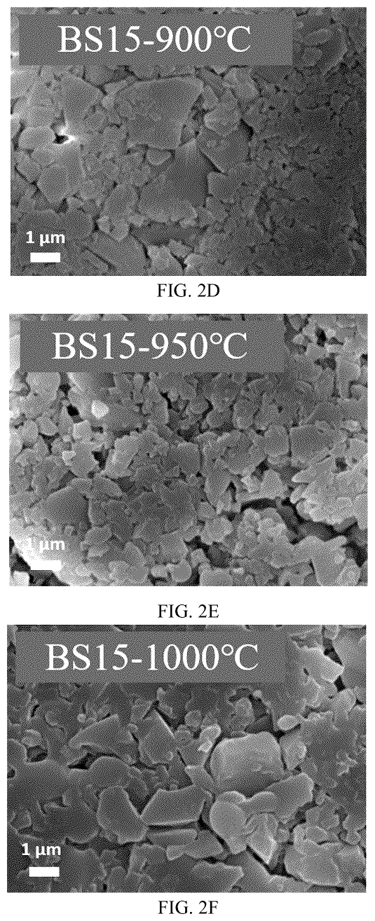

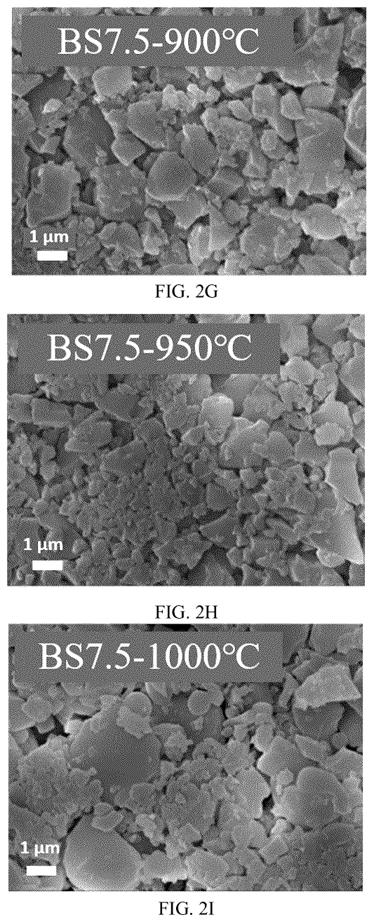

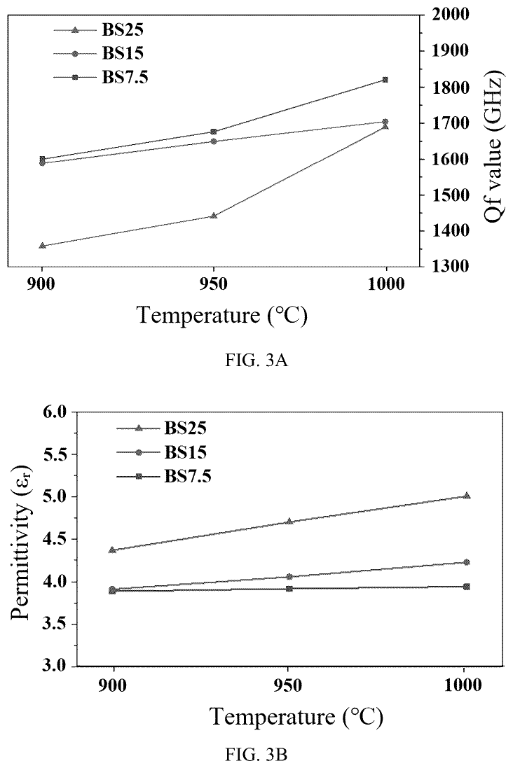

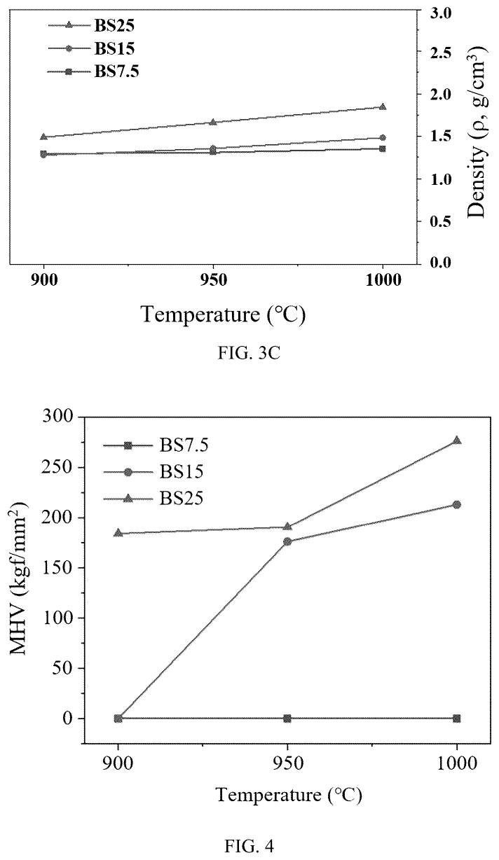

SEM micrographs of BS glass ceramics were captured using a field-emission scanning electron microscope (FE-SEM). As shown in FIG. 2A, FIG. 2B, FIG. 2C, FIG. 2D, FIG. 2E, FIG. 2F, FIG. 2G, FIG. 2H, and FIG. 2I, the BS7.5, BS15, and BS25 prepared at sintering temperatures of 900° C. and 950° C. maintained powder form with an amorphous phase structure. As the sintering temperature increased to 1000° C., it can be seen that the grain growth of BS glass ceramics became more obvious with increasing H₃BO₃ additive content, and its density increased, as shown in FIG. 3C.

### [Dielectric Properties of BS Glass Ceramics]

When 50% of SiO₂ exhibited cristobalite structure, the permittivity of the amorphous state increases from 3.4 to 4.4. However, in this case, the sintering temperature needs to reach as high as 1000° C. As shown in FIG. 3B, at sintering temperatures of 900 to 950° C., the overall permittivities (εᵣ) ranged between 3.8 and 4.7 while the Qf value decreased. Among them, BS7.5 prepared at a sintering temperature of 1000° C. produced a higher amount of cristobalite phase and exhibited a slightly elevated Qf value, reaching 1800 GHz, as shown in FIG. 3A.

### [Mechanical Properties of BS Glass Ceramics]

As shown in FIG. 4, the hardness of BS glass ceramics increased with the sintering temperature and also increased with the amount of H₃BO₃ additive, resulting in the formation of more cristobalite phase.

### [Microstructure of LBS Glass Ceramics]

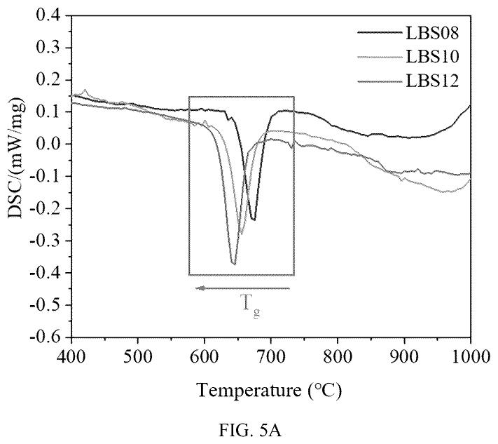

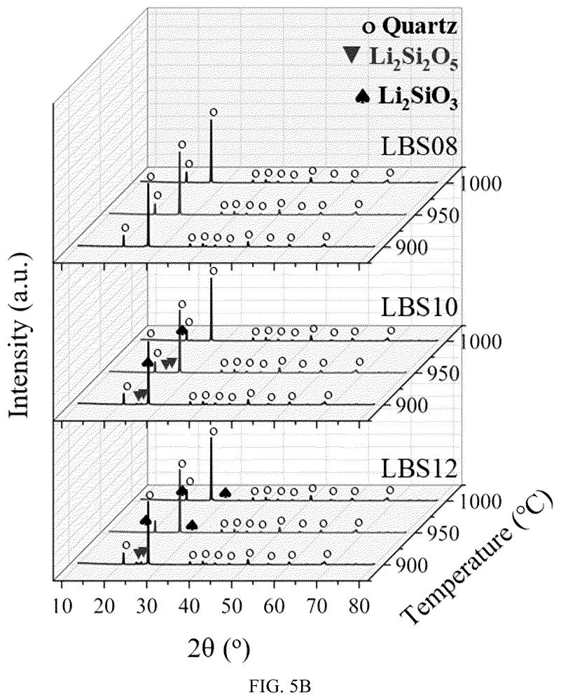

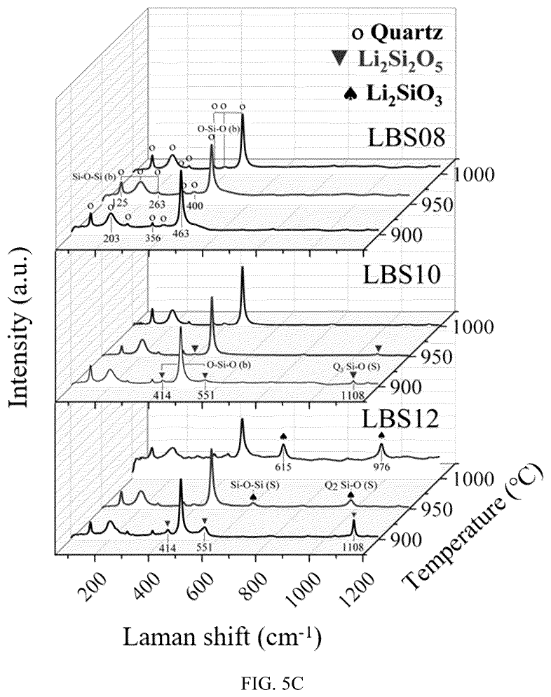

Thermal analysis on LBS glass ceramics was performed using differential scanning calorimetry (DSC). The DSC curve of LBS glass ceramics was shown in FIG. 5A, indicating that the network structure of LBS glass ceramics was composed of [SiO₄]tetrahedron, with alkali metal and alkaline earth metal ions bonded in the network structure via non-bridging oxygen (NBO). The main factors influencing the glass transition temperature (Tg) were the changes in ionic radius and atomic bond strength. Since Li⁺ ions had a smaller radius, they could enhance the crystallinity of the glass. Also, both Tg and the crystallization temperature (Tc) decreased as the Li₂CO₃ content increased.

Additionally, the microstructure of each LBS glass ceramic prepared at different sintering temperatures was also analyzed using XRD patterns and Raman spectra. Since LBS06 still remained a cristobalite structure after the steps of melting and water quenching, no further analysis was conducted (not shown). The XRD patterns in FIG. 5B displayed the formation of crystalline phases in LBS08, LBS10, and LBS12 glass ceramics, confirming that Li₂CO₃ could serve as an effective nucleating agent. Furthermore, the phase quantification results of the XRD patterns were shown in Table 1, indicating that as the sintering temperature increased, the quartz phase gradually decreased, being replaced by Li₂Si₂O₅ and Li₂SiO₃ phases, with the Li₂SiO₃ phase beginning to develop at 950° C.

TABLE 1

| | Sintering temperature | | | | | | | | |
|---|---|---|---|---|---|---|---|---|---|
| | 900° C. | | | 950° C. | | | 1000° C. | | |
| Glass ceramics | LBS08 | LBS10 | LBS12 | LBS08 | LBS10 | LBS12 | LBS08 | LBS10 | LBS12 |
| Quartz | 100 | 92.9 | 82.7 | 100 | 98.1 | 93.5 | 100 | 97.3 | 92.4 |
| Li₂Si₂O₅ | 0 | 7.1 | 17.3 | 0 | 1.5 | 0 | 0 | 0 | 0 |
| Li₂SiO₃ | 0 | 0 | 0 | 0 | 0.3 | 6.5 | 0 | 2.7 | 7.6 |

The Raman spectra of LBS08, LBS10, and LBS12 prepared at different sintering temperatures were shown in FIG. 5C. It could be observed that the primary phase of LBS08 prepared at a sintering temperature of 900 to 1000° C. was the quartz phase. LBS10 and LBS12 prepared at a sintering temperature of 900° C. corresponded to the Li₂Si₂O₅ phase structure. When the sintering temperature increased to 950° C., LBS12 exhibited the Li₂SiO₃ phase. With the increase in Li₂CO₃ content, a large amount of free oxygen was provided, breaking the Si—O—Si bonds and converting them into non-bridging oxygen atoms, which further validated the conclusion from the XRD patterns and the phase quantification.

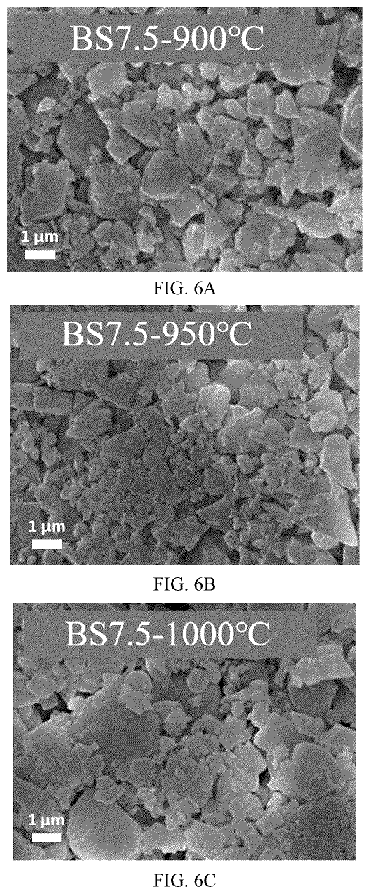

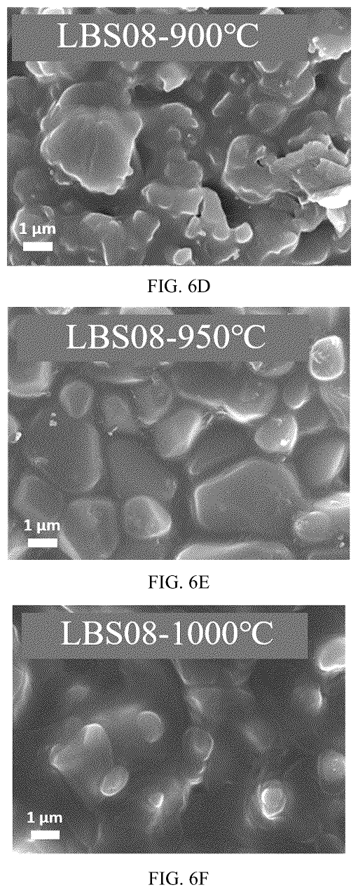

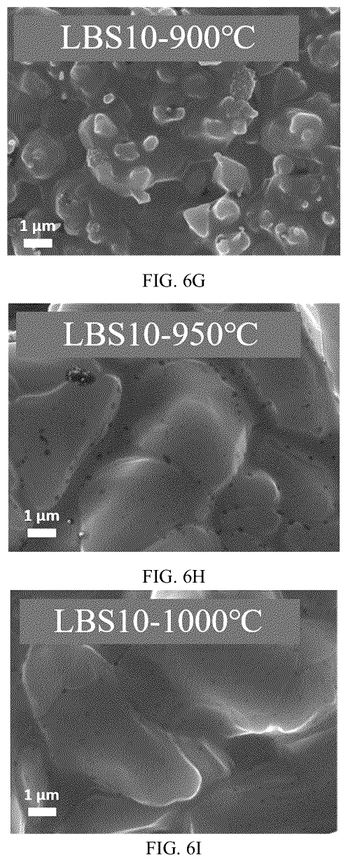

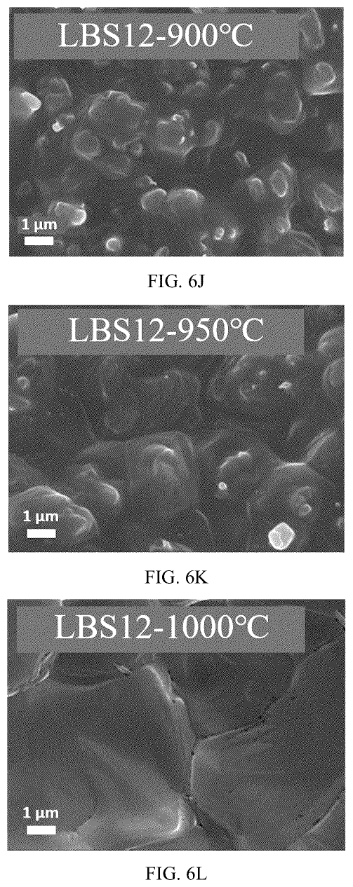

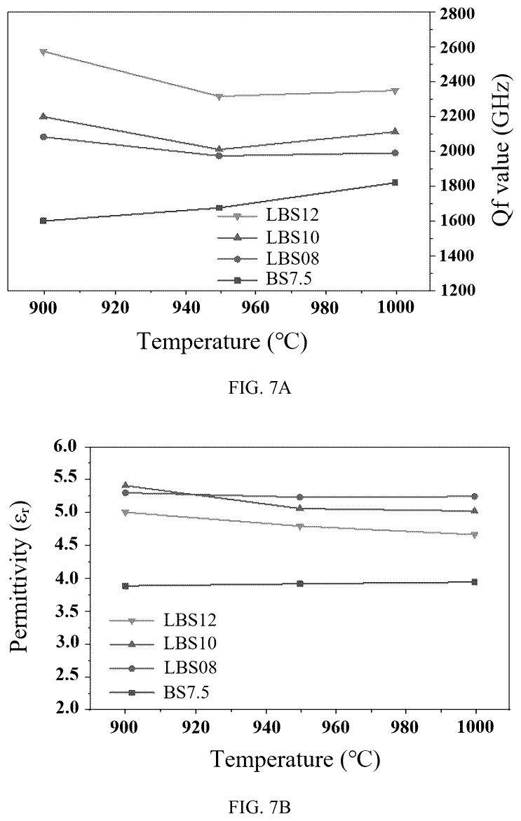

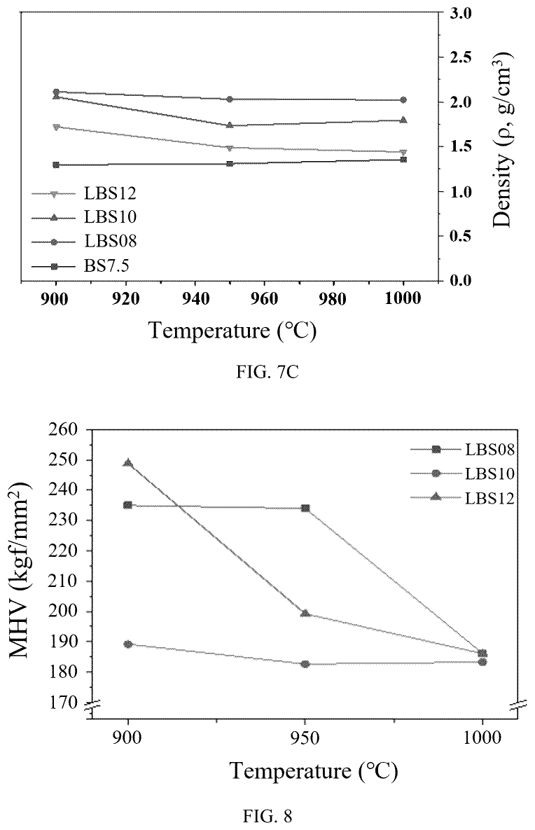

The SEM micrographs of LBS glass ceramics were shown in FIG. 6A, FIG. 6B, FIG. 6C, FIG. 6D, FIG. 6E, FIG. 6F, FIG. 6G, FIG. 6H, FIG. 6I, FIG. 6J, FIG. 6K, FIG. 6L. It could be observed that the addition of Li₂CO₃ made the grain structure of the prepared LBS glass ceramics sintered at sintering temperature of 900° C. more distinct. When the sintering temperature reached 950° C., the grain size of LBS10 and LBS12 obviously increased due to the formation of the Li₂SiO₃ secondary phase. Compared to BS glass ceramic (BS7.5), as the sintering temperature increased, the shrinkage rate and density of LBS glass ceramics (LBS08, LBS10, and LBS12) decreased. This was due to the precipitation of crystalline phases, causing volume expansion, thereby resulting in density reduction. As shown in FIG. 7C, the density of LBS08, LBS10, and LBS12 prepared at different sintering temperatures was approximately 1.5 to 2.0 g/cm³.

### [Dielectric Properties of LBS Glass Ceramics]

The Qf values and permittivities of LBS glass ceramics were respectively shown in FIG. 7A and FIG. 7B, wherein the Qf value of LBS12 prepared at different sintering temperatures was about 2300 to 2600 GHz. It could be observed that LBS08, in which a small amount of Li₂CO₃ was added, still exhibited the quartz phase, resulting in its electrical properties inferior to those of LBS10 and LBS12. In comparison, the range of permittivities of LBS10 and LBS12 prepared at sintering temperatures of 900 to 950° C. was 4.7 to 5.4 and the range of Qf values was 1900 to 2600 GHz. The LBS12 prepared at sintering temperatures of 900 to 1000° C. exhibited lower permittivities between 4.7 to 5.0, and Qf values of about 2600 GHz simultaneously, fully meeting the requirements for LTCC materials, and LBS12 exhibited the highest hardness when prepared at the sintering temperature of 900° C., i.e. MHV=249 (kgf/mm²), as shown in FIG. 8. In summary, the preparation method of LBS glass ceramics of the present disclosure enabled the preparation of glass ceramics that met the low-temperature sintering requirements for LTCC materials by using a low sintering temperature of 900 to 950° C. In particular, the LBS12 glass ceramic prepared with raw materials comprising 12 wt % Li₂CO₃ at a sintering temperature of 900° C. had the best parameters.

What is claimed is:

1. A Li₂O—B₂O₃—SiO₂ system glass ceramic, characterized in that the Li₂O—B₂O₃—SiO₂ system glass ceramic comprises 89.87 to 92.86 wt % SiO₂, 4.53 to 4.71 wt % B₂O₃, and 2.61 to 5.42 wt % Li₂O.

2. The Li₂O—B₂O₃—SiO₂ system glass ceramic of claim 1, wherein a permittivity (εᵣ) value of the Li₂O—B₂O₃—SiO₂ system glass ceramic is 4.7 to 5.4.

3. The Li₂O—B₂O₃—SiO₂ system glass ceramic of claim 1, wherein a Qf value of the Li₂O—B₂O₃—SiO₂ system glass ceramic is 1900 to 2600 GHz.

4. The Li₂O—B₂O₃—SiO₂ system glass ceramic of claim 1, wherein a Vickers microhardness (MHV) value of the Li₂O—B₂O₃—SiO₂ system glass ceramic is 190 to 249 kgf/mm².

5. The Li₂O—B₂O₃—SiO₂ system glass ceramic of claim 1, wherein a density of the Li₂O—B₂O₃—SiO₂ system glass ceramic is 1.5 to 2.0 g/cm³.

6. The Li₂O—B₂O₃—SiO₂ system glass ceramic of claim 1, wherein the Li₂O—B₂O₃—SiO₂ system glass ceramic is obtained by sintering at a sintering temperature of 800 to 1100° C.

7. A preparation method of the Li₂O—B₂O₃—SiO₂ system glass ceramic of claim 1, wherein the method comprises following steps: mixing raw materials comprising
at least Li₂CO₃, H₃BO₃, and SiO₂; melting; water quenching; grinding; wet fine grinding; adding a binder; and low-temperature sintering to obtain the Li₂O—B₂O₃—SiO₂ system glass ceramic, and
the method is characterized in that the raw materials comprise 6 to 12 wt % Li₂CO₃, 6.6 to 7.5 wt % H₃BO₃, and 80.5 to 86.5 wt % SiO₂, and the low-temperature sintering step is performed at a sintering temperature of 800 to 1100° C.

8. The method of claim 7, wherein the melting step of the method is performed in a furnace at a temperature of 1500 to 1580° C. wherein the temperature of 1500 to 1580° C. is maintained for 4 to 8 hours.

9. The method of claim 7, wherein the wet fine grinding step of the method is performed until particle size is <5 μm.

10. The method of claim 7, wherein the low-temperature sintering step of the method is performed for 1 to 4 hours.
